(19) United States
(12) Patent Application Publication
(10) Pub. No.: US 2020/0385020 A1
(43) Pub. Date: Dec. 10, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Misa Komuro, Wako-shi (JP)

(21) Appl. No.: 16/869,635

(22) Filed: May 8, 2020

(30) Foreign Application Priority Data
May 17, 2019 (JP) 2019-093696

(51) Int. Cl. B60W 60/00; G08G 1/16; B60W 30/095; B60W 30/09; B60W 10/20

(52) U.S. Cl. CPC B60W 60/0016; G08G 1/16; B60W 30/0953; B60W 30/0956; B60W 10/06; B60W 60/0027; B60W 60/0017; B60W 10/20; B60W 30/09

(57) ABSTRACT

A vehicle control device includes: a recognizer configured to recognize a surrounding environment of an own vehicle; a first trajectory generator configured to generate a first trajectory along which the own vehicle is traveling; a second trajectory generator configured to generate a second trajectory along which an oncoming vehicle is predicted to be traveling; and a driving controller configured to perform driving control of the own vehicle. The second trajectory generator moves a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.

### CROSS-REFERENCE TO RELATED APPLICATION

Priority is claimed on Japanese Patent Application No. 2019-093696, filed May 17, 2019, the content of which is incorporated herein by reference.

### BACKGROUND

### Field of the Invention

The present invention relates to a vehicle control device, a vehicle control method, and a storage medium.

### Description of Related Art

In recent years, studies of autonomous vehicle control have been conducted. In relation to this technology, a driving support device that causes an own vehicle to retreat to a second spot at which the own vehicle can pass by an oncoming vehicle through automated driving based on road information and positional information of the own vehicle when the own vehicle meets the oncoming vehicle in a road with a narrow width in which the own vehicle cannot pass by the oncoming vehicle, and causes the own vehicle to advance through automated driving after the own vehicle passes by the oncoming vehicle is known (for example, see Japanese Unexamined Patent Application, First Publication No. 2018-189616).

### SUMMARY

However, when an obstacle is on a traveling road, a traveling trajectory along which an oncoming vehicle is predicted to be traveling in future considerably deviates from a traveling trajectory generated using the shape or the like of a traveling road as a standard, precision of a predicted trajectory of the oncoming vehicle is lowered in some cases.

Aspects of the present invention have been devised in consideration of such circumstances and one objective of the present invention is to provide a vehicle control device, a vehicle control method, and a storage medium capable of predicting a traveling trajectory of an oncoming vehicle with higher precision when an obstacle is on a traveling road.

A vehicle control device, a vehicle control method, and a storage medium according to the present invention adopt the following configurations.

(1) According to an aspect of the present invention, a vehicle control device includes: a recognizer configured to recognize a surrounding environment of an own vehicle; a first trajectory generator configured to generate a first trajectory along which the own vehicle is traveling based on a recognition result of the recognizer; a second trajectory generator configured to generate a second trajectory along which an oncoming vehicle is predicted to be traveling in a direction in which the own vehicle encounters the oncoming vehicle based on the recognition result of the recognizer; and a driving controller configured to perform driving control on one or both of a speed and steering of the own vehicle based on whether the first trajectory interferes with the second trajectory. The second trajectory generator moves a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the recognizer recognizes that the obstacle is on the traveling road.

(2) In the vehicle control device according to the aspect (1), the second trajectory may include a plurality of second trajectory points formed at predetermined intervals in a longitudinal direction of the traveling road. The second trajectory generator may determine an amount of movement of the second trajectory points in the width direction based on a distance between a position of the second trajectory point near the standard position and the standard position in the longitudinal direction of the traveling road.

(3) In the vehicle control device according to the aspect (2), the second trajectory generator may cause the amount of the movement of the second trajectory points in the width direction to be less than a distance between the standard position and the boundary as the distance between the position of the second trajectory point near the standard position and the standard position in the longitudinal direction of the traveling road increases.

(4) In the vehicle control device according to the aspect (1), when the first trajectory is predicted to interfere with the second trajectory before the oncoming vehicle passes by the obstacle, the driving controller may cause the own vehicle to stop until the oncoming vehicle passes by the obstacle.

(5) In the vehicle control device according to the aspect (1), the driving controller may cause the own vehicle to stop when the oncoming vehicle is predicted to arrive at a predetermined position on the traveling road earlier than the own vehicle, and the driving controller causes the own vehicle to travel along the first trajectory when the own vehicle is predicted to arrive at the predetermined position earlier than the oncoming vehicle.

(6) In the vehicle control device according to the aspect (1), when the recognizer recognizes that an obstacle is on the traveling road, the first trajectory generator may move a part of the first trajectory in a direction away from a boundary of the traveling road in a width direction of the traveling road in accordance with a distance between the standard position and the boundary of the traveling road opposite to the standard position in the width direction of the traveling road when viewed from a center portion of the obstacle. The driving controller may cause the own vehicle to stop when a first timing at which the own vehicle is moved in the direction away from the boundary along the first trajectory is later than or the same as a second timing at which the oncoming vehicle moves in the direction away from the boundary along the second trajectory, and the driving controller causes the own vehicle to travel along the first trajectory when the first timing is earlier than the second timing.

(7) In the vehicle control device according to the aspect (4), the driving controller may cause the own vehicle to stop at a position located a predetermined distance before a position predicted to return to a trajectory before the movement of the traveling road in the direction in which the second trajectory moves away from the boundary in the width direction of the traveling road after the oncoming vehicle passes by the obstacle.

(8) In the vehicle control device according to the aspect (1), when the recognizer recognizes an obstacle near a boundary of a recognizable range of the traveling road and the recognizer does not recognize an oncoming vehicle, the second trajectory generator may generate the second trajectory on assumption that a virtual oncoming vehicle is at a position which is farther from the obstacle when viewed from the own vehicle and is located at a predetermined distance from the obstacle or the recognizable range.

(9) According to another aspect of the present invention, there is a vehicle control method causing a computer: to recognize a surrounding environment of an own vehicle; to generate a first trajectory along which the own vehicle is traveling based on a recognition result; to generate a second trajectory along which an oncoming vehicle is predicted to be traveling in a direction in which the own vehicle encounters the oncoming vehicle based on the recognition result; to perform driving control on one or both of a speed and steering of the own vehicle based on whether the first trajectory interferes with the second trajectory; and to move a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.

(10) According to still another aspect of the present invention, a computer-readable non-transitory storage medium stores a program causing a computer: to recognize a surrounding environment of an own vehicle; to generate a first trajectory along which the own vehicle is traveling based on a recognition result; to generate a second trajectory along which an oncoming vehicle is predicted to be traveling in a direction in which the own vehicle encounters the oncoming vehicle based on the recognition result; to perform driving control on one or both of a speed and steering of the own vehicle based on whether the first trajectory interferes with the second trajectory; and to move a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.

According to the aspects (1) to (10), it is possible to predict a traveling trajectory of an oncoming vehicle with higher precision when an obstacle is on a traveling road.

### BRIEF DESCRIPTION OF THE DRAWINGS

FIG. 1 is a diagram showing a configuration of a vehicle system in which a vehicle control device according to an embodiment is used.

FIG. 2 is a diagram showing a functional configuration of a first controller and a second controller.

FIG. 3 is a diagram showing an example of a scenario in which an own vehicle passes by a target vehicle in a case in which no obstacle is on a traveling road.

FIG. 4 is a diagram showing an example of a scenario in which an own vehicle passes by an oncoming vehicle in a case in which obstacles are on a traveling road.

FIG. 5 is a diagram showing movement in a part of a second trajectory.

FIG. 6 is a diagram showing a process of an interference determiner when obstacles are on a traveling road.

FIG. 7 is a diagram showing a stop position of an own vehicle.

FIG. 8 is a flowchart showing an example of a flow of a process performed by an automated driving control device according to an embodiment.

FIG. 9 is a diagram showing another example in which a risk area is generated.

FIG. 10 is a diagram showing movement in a part of a first trajectory according to a third modification example.

FIG. 11 is a diagram showing a fourth modification example.

FIG. 12 is a diagram showing an example of a hardware configuration of the automated driving control device according to an embodiment.

### DESCRIPTION OF EMBODIMENTS

Hereinafter, embodiments of a vehicle control device, a vehicle control method, and a storage medium according to the present invention will be described with reference to the drawings. Hereinafter, an embodiment of an automated driving vehicle will be described. In automated driving, for example, one or both of steering or an accelerated or decelerated speed of a vehicle automatedly are controlled to perform automated control. In an automated driving vehicle, driving control may be performed through a manual operation of a user. Hereinafter, a case in which laws and regulations for left-hand traffic are applied will be described. However, when laws and regulations for right-hand traffic are applied, the left and right may be reversed.

### [Overall Configuration]

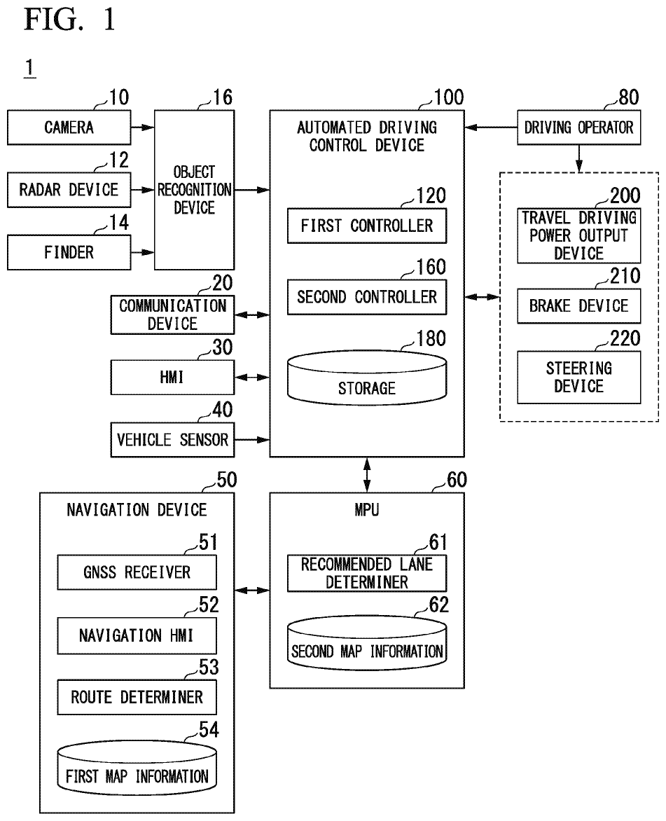

FIG. 1 is a diagram showing a configuration of a vehicle system 1 in which a vehicle control device according to an embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, and a steering device 220. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added. The automated driving control device 100 is an example of a “driving control device.”

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, and the like. For example, the camera 10 repeatedly images the surroundings of the own vehicle M periodically. The camera 10 may be a stereo camera.

The radar device 12 radiates radio waves such as millimeter waves to the surroundings of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with other vehicles around the own vehicle M using, for example, a cellular network, a Wi-Fi network, Bluetooth (registered trademark), dedicated short range communication (DSRC) or the like or communicates with various server devices via a wireless base station.

The HMI 30 presents various types of information to occupants of the own vehicle M and receives input operations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include a curvature of a road and point of interest (POI) information. The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel, a heteromorphic steering wheel, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120, a second controller 160, and a storage 180. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a detachably mounted storage medium such as a DVD, a CD-ROM, or the like so that the storage medium (a non-transitory storage medium) is mounted on a drive device to be installed on the HDD or the flash memory of the automated driving control device 100. The storage 180 is realized by the above-described storage device.

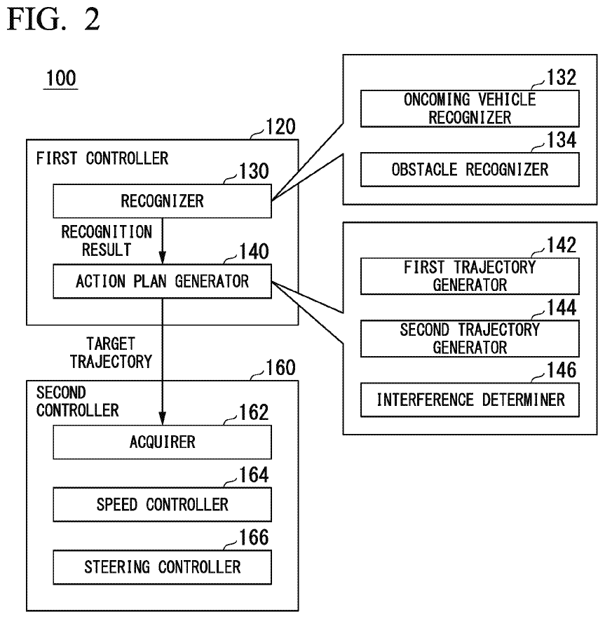

FIG. 2 is a diagram showing a functional configuration of the first controller 120 and the second controller 160. The first controller 120 includes, for example, a recognizer 130 and an action plan generator 140. A combination of the action plan generator 140 and the second controller 160 is an example of a “driving controller.” The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes a surrounding environment of the own vehicle M based on information input from the camera 10, the radar device 12, and the finder 14 via the object recognition device 16. For example, the recognizer 130 recognizes states such as a position, a speed, acceleration, or the like of an object near the own vehicle M based on a recognition result of the object recognition device 16. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include acceleration or jerk of the object or an “action state” (for example, whether a vehicle is changing a lane or is attempting to change the lane).

The recognizer 130 recognizes, for example, a lane in which the vehicle M is traveling (a travel lane). For example, the recognizer 130 recognizes the travel lane by comparing patterns of road mark lines (for example, arrangement of continuous lines and broken lines) obtained from the second map information 62 with patterns of road mark lines around the own vehicle M recognized from images captured by the camera 10. The recognizer 130 may recognize a travel lane by mainly recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, red signals, toll gates, and other road events.

The recognizer 130 recognizes a position or a posture of the own vehicle M in the travel lane when the recognizer 130 recognizes the travel lane. For example, the recognizer 130 may recognize a deviation from the middle of a lane of a standard point of the own vehicle M and an angle formed with a line extending along the middle of a lane and the travel direction of the own vehicle M as a relative position and posture of the own vehicle M to the travel lane. Instead of this, the recognizer 130 may recognize a position or the like of the standard point of the own vehicle M with respect to a side end portion (a road mark line or a road boundary) of any travel lane as the relative position of the own vehicle M to the travel lane. The recognizer 130 includes, for example, an oncoming vehicle recognizer 132 and an obstacle recognizer 134. The details of functions of the oncoming vehicle recognizer 132 and the obstacle recognizer 134 will be described later.

The action plan generator 140 generates a target trajectory (hereafter referred to as a first trajectory) along which the own vehicle M travels in future automatedly (irrespective of an operation or the like by a driver) so that the own vehicle M is traveling along a recommended lane determined by the recommended lane determiner 61 and can handle a surrounding environment of the own vehicle M in principle, and generates an action plan to perform automated driving of the own vehicle M based on the generated first trajectory.

The action plan generator 140 may generate an action plan based on an automated driving event when the traveling trajectory is generated. As the automated driving event, there are a constant speed traveling event, a low-speed following traveling event, a lane changing event, a branching event, a joining event, a takeover event, and the like. The action plan generator 140 generates the first trajectory in accordance with an activated event.

The action plan generator 140 includes, for example, a first trajectory generator 142, a second trajectory generator 144, and an interference determiner 146. The details of functions of the first trajectory generator 142, the second trajectory generator 144, and the interference determiner 146 will be described later.

The second controller 160 controls the travel driving power output device 200, the brake device 210, and the steering device 220 so that the own vehicle M passes along the first trajectory generated by the action plan generator 140 at a scheduled time.

The second controller 160 includes, for example, an acquirer 162, a speed controller 164, and a steering controller 166. The acquirer 162 acquires information regarding the first trajectory generated by the action plan generator 140 and stores the information in a memory (not shown). The speed controller 164 controls the travel driving power output device 200 or the brake device 210 based on a speed element incidental to the first trajectory stored in the memory. The steering controller 166 controls the steering device 220 in accordance with a curve state of traveling stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the first trajectory in combination.

The travel driving power output device 200 outputs a travel driving power (torque) for causing the own vehicle M to travel to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

[Driving Control when Own Vehicle Passes by Oncoming Vehicle]

Hereinafter, driving control when the own vehicle M passes by an oncoming vehicle on a traveling road will be described with reference to the drawings.

### [When No Obstacle is on Traveling Road]

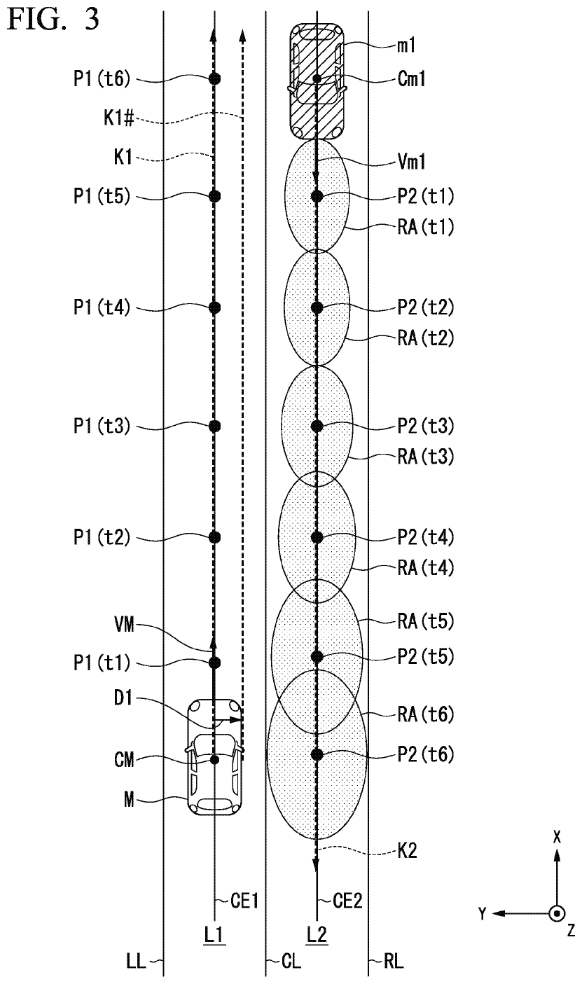

First, a case in which obstacles are on a traveling road will be described. FIG. 3 is a diagram showing an example of a scenario in which an own vehicle passes by a target vehicle in a case in which no obstacle is on a traveling road. In the example of FIG. 3, a first lane L1 and a second lane L2 are shown as the traveling road. The lanes L1 and L2 are mutually adjacent lanes. The lane L1 is a lane which is demarcated by road demarcation lines LL and CL and in which a vehicle traveling in a +X direction shown in FIG. 3 is traveling. The lane L2 is a lane demarcated by road demarcation lines CL and RL and is an oncoming lane (that is, a lane in which a vehicle traveling in a −X direction is traveling) of the lane L1. In the example of FIG. 3, it is assumed that the own vehicle M is traveling at a speed VM in the lane L1 and an oncoming vehicle m1 traveling in an oncoming direction to the own vehicle M is traveling at a speed Vm1 in the lane L2. The road demarcation lanes LL, CL, and RL are examples of a “boundary.”

### [Oncoming Vehicle Recognizer]

The oncoming vehicle recognizer 132 recognizes the oncoming vehicle m1 traveling in the second lane L2 through pattern matching in which feature information such as a shape, a color, or the like of an object is used by the object recognition device 16. The oncoming vehicle recognizer 132 derives a speed Vm1 of the oncoming vehicle M based on a relative speed of the oncoming vehicle m1, the speed VM of the own vehicle M, and a traveling direction of each of the own vehicle M and the oncoming vehicle m1.

### [First Trajectory Generator]

The first trajectory generator 142 generates a first trajectory along which the own vehicle M is traveling based on a surrounding environment of the own vehicle M recognized by the recognizer 130. For example, the first trajectory generator 142 uses a middle portion (hereinafter referred to as a first middle portion) CE1 in the transverse direction (a lane width direction) of the lane L1 in which the own vehicle M is traveling as a standard to generate a plurality of first trajectory points P1 at which the own vehicle M aims to arrive in future at predetermined intervals in the longitudinal direction of the lane L1 so that a standard position (for example, a center CM) of the own vehicle M passes through the first middle portion CE1. For example, the first trajectory is expressed by sequentially arranging spots (the first trajectory points P1) at which the own vehicle M arrives. The first trajectory points P1 are, for example, formed at the predetermined interval in the longitudinal direction of the lane L1. The first trajectory points P1 are spots at which the own vehicle M will arrive for each predetermined travel distance (for example, about several [m]) in a distance along a road. Apart from the first trajectory points, target acceleration and a target speed are generated as parts of the first trajectory for each of predetermined sampling times (for example, every fractions of a second). The first trajectory may include speed elements. The first trajectory points P1 may be positions at which the own vehicle M will arrive at the sampling time for each predetermined sampling time. In this case, information regarding the target acceleration or the target speed is expressed according to an interval between the first trajectory points. In the example of FIG. 3, the first trajectory points P1(t1) to P1(t6) formed over time and a first trajectory K1 passing through each trajectory point are shown (where t1 to t6 indicate time: the same applies below).

### [Second Trajectory Generator]

The second trajectory generator 144 generates a traveling trajectory along which the oncoming vehicle m1 is predicted to travel in future (hereinafter also referred to as a second trajectory) based on a recognition result by the oncoming vehicle recognizer 132. For example, the second trajectory generator 144 uses a middle portion (hereinafter referred to as a second middle portion) CE2 in the transverse direction of the lane L2 in which the oncoming vehicle m1 is traveling as a standard to generate a plurality of first trajectory points P2 at which the oncoming vehicle m2 aims to arrive in future at predetermined intervals in the longitudinal direction of the lane L2 so that a standard position (for example, a center Cm1) of the oncoming vehicle m1 passes through the second middle portion CE2. For example, the second trajectory is expressed by sequentially arranging spots (the second trajectory points P2) at which the oncoming vehicle m1 is predicted to arrive. The second trajectory points P2 are, for example, formed at the predetermined interval in the longitudinal direction of the lane L2. The second trajectory points P2 are spots at which the oncoming vehicle m1 will arrive for each predetermined travel distance (for example, about several [m]) in a distance along a road. Apart from the second trajectory points, target acceleration and a target speed may be generated as parts of the second trajectory for each of predetermined sampling times (for example, about a decimal point of a second). The second trajectory may include a speed element. The second trajectory points P2 may be positions at which the oncoming vehicle m1 is predicted to arrive at the sampling time for each predetermined sampling time. In this case, information regarding the target acceleration or the target speed is expressed according to an interval between the second trajectory points. In the example of FIG. 3, the second trajectory points P2(t1) to P2(t6) formed over time and a second trajectory K2 passing through each trajectory point are shown.

### [Interference Determiner]

The interference determiner 146 determines whether the first trajectory K1 generated by the first trajectory generator 142 interferes with the second trajectory K2 generated by the second trajectory generator 144. Specifically, the interference determiner 146 sets an area where it is assumed that the behavior of an oncoming vehicle m1 will deviate in future due to a change in a speed or a steering amount changes as a risk area RA and determines whether the set risk area RA will interfere with a trajectory along which the standard position of the own vehicle M passes at the time of traveling along the first trajectory K1. In the example of FIG. 3, risk areas RA(t1) to RA(t6) set using the second trajectory points P2(t1) to P2(t6) as standards are generated. The risk areas RA(t1) to RA(t6) enlarge with the passage of time. The standard position of the own vehicle M is a position of an end (in the example of FIG. 3, the left end of the own vehicle M) on the oncoming lane side of the own vehicle M and the trajectory along which the standard position of the own vehicle M passes is an offset trajectory K1# offset (moved) from the first trajectory K1 to the oncoming lane side (the right side in the drawing) by a distance D1 from the center CM of the own vehicle M to the left end. The interference determiner 146 compares the offset trajectory K1# of the own vehicle M from time t1 to time t6 with the risk areas RA(t1) to RA(t6) and determines that the first trajectory K1 does not interfere with the second trajectory K2 (in other words, the own vehicle M does not come into contact with the oncoming vehicle m1 in future) when there is no intersection portion. When there is an intersection portion, the interference determiner 146 determines that the first trajectory K1 does not interfere with the second trajectory K2 (in other words, the own vehicle M is likely to come into contact with the oncoming vehicle m1 in future). In the example of FIG. 3, since the offset trajectory K1# does not intersect the risk areas RA(t1) to RA(t6), the interference determiner 146 determines that the own vehicle M does not come into contact with the oncoming vehicle m1 in future. Accordingly, the second controller 160 causes the own vehicle M to travel along the first trajectory K1.

### [When Obstacles are on Traveling Road]

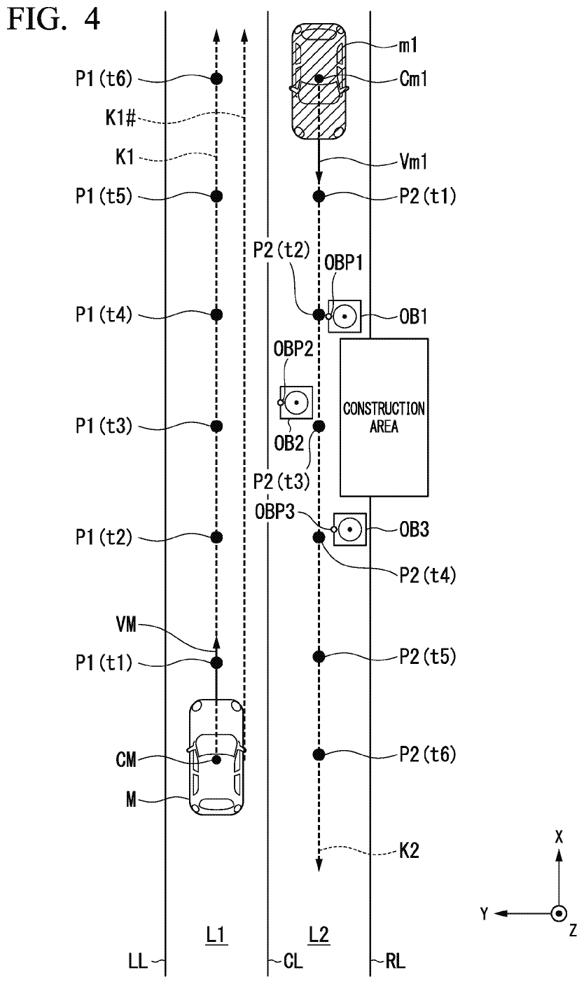

Next, a case in which obstacles are on a traveling road will be described. Hereinafter, a scenario in which the width of a traveling road is narrowed to the degree that the own vehicle M and the oncoming vehicle m1 cannot pass by each other in a section in which there is an obstacle since the obstacle is on the traveling road will be described. FIG. 4 is a diagram showing an example of a scenario in which the own vehicle passes by an oncoming vehicle in a case in which obstacles are on a traveling road. The example of FIG. 4 shows a scenario in which a passage prohibition area such as a construction area is in a part of the lane L2, the construction area is demarcated, and obstacles OB1 to OB3 are arranged on the lane L2 near the passage prohibition area so that a vehicle cannot enter the construction area in contrast to the scenario of FIG. 3 described above. The obstacles are, for example, traffic cones (examples of safety instruments) or the like. Examples of the obstacles according to the embodiment may include not only traffic cones but also objects having fallen from front vehicles (for example, trucks) or the like, trees falling over a traveling road, various objects such as parked vehicles or pedestrians, construction sites, holes through which the own vehicle M cannot pass due to damage or collapse of a road.

### [Obstacle Recognizer]

The obstacle recognizer 134 recognizes the obstacles OB1 to OB3 which are on the traveling road (the lanes L1 and L2) based on a recognition result of the object recognition device 16. The obstacle recognizer 134 recognizes a position, a shape, a size, or the like of an obstacle on the traveling road. The obstacle recognizer 134 may recognize a movement direction, a movement speed, or the like when an obstacle is an object such as a pedestrian capable of moving.

The second trajectory generator 144 moves a part of the second trajectory K2 generated in a scenario in which the above-described obstacle does not exist when the recognizer 130 recognizes an obstacle on the traveling road. For example, the second trajectory generator 144 sets a standard position of each of the obstacles OB1 to OB3. The standard position of the obstacle may be, for example, a position farthest from the road demarcation line RL (the maximum value of the Y axis coordinate), may be a position closest to the oncoming vehicle m1, or may be a position obtained by adding a predetermined margin from the center of an obstacle. A plurality of standard positions may be set for one obstacle. In the example of FIG. 4, standard points OBP1 to OBP3 associated with the obstacles OB1 to OB3 are set. The standard points OBP1 to OBP3 are positions of ends of the obstacles at the time of movement from the centers of the obstacles OB1 to OB3 in the transverse direction (the side of the road demarcation line CL or the +Y direction) of the lane L2. The second trajectory generator 144 moves a part of the second trajectory K2 in a direction away from the line RL in the width direction of the lane L2 in accordance with distances between the line RL and the standard positions OBP1 to OBP3. The line RL is a boundary opposite to the standard positions OBP1 to OBP3 in the width direction of the lane L2 when viewed from the center of the obstacles OB1 to OB3.

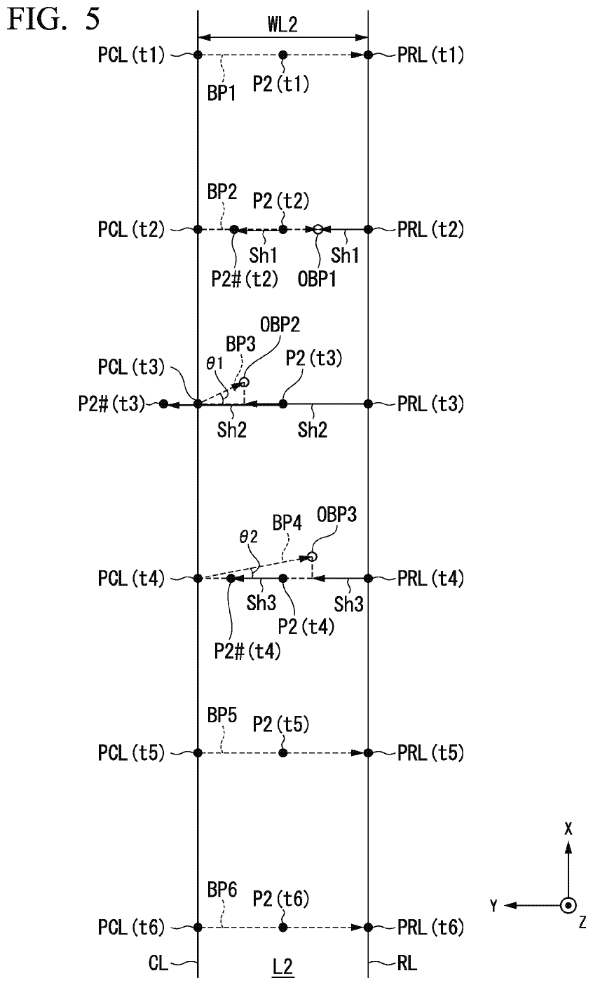

FIG. 5 is a diagram showing movement in a part of the second trajectory K2. The example of FIG. 5 shows the second trajectory points P2(t1) to P2(t6) and the standard positions OBP1 to OBP3 of the obstacles OB1 to OB3 in the lane L2. The example of FIG. 5 shows points PCL(t1) to PCL(t6) intersecting the road demarcation line CL when the second trajectory points P2(t1) to P2(t6) are moved in the transverse direction (in the drawing, the +Y direction) of the lane L2, and shows points PRL(t1) to PRL(t6) intersecting the road demarcation line RL when the second trajectory points P2(t1) to P2(t6) are moved in the transverse direction (in the drawing, the −Y direction) of the lane L2.

The second trajectory generator 144 determines, for example, trajectory points to be moved and movement amounts (shift amounts) among the second trajectory points P2(t1) to P2(t6) included in the second trajectory K2 based on distances between the points PCL(t1) to PCL(t6) and the points PRL(t1) to PRL(t6) and distances between the points PCL(t1) to PCL(t6) and the standard positions OBP1 to OBP3.

For example, the second trajectory generator 144 does not move the second trajectory point P2(t1), for example, since an inter-point distance BP1 between the point PCL(t1) and the point PRL(t1) at time t1 is equal to a lane width WL2 of the lane L2 and the standard positions OBP1 to OBP3 are not present within at a distance shorter than the lane width WL2. The second trajectory point P2(t5) and the second trajectory point P2(t6) are not moved since an inter-point distance BP5 between the point PCL(t5) and the point PRL(t5) and an inter-point distance BP6 between the point PCL(t6) and the point PRL(t6) are equal to the lane width WL2 even at times t5 and t6 and the standard positions OBP1 to OBP3 do not exist at a distance shorter than the lane width WL2.

The second trajectory generator 144 moves the second point P2(t2) since a distance BP2 between the point PCL(t2) and the standard position OBP1 which is the closest among the standard positions OBP1 to OBP3 is shorter than the lane width WL2 at time t2. In the case of time t2, the standard position OBP1 and the second trajectory point P2(t2) exist at positions horizontal to the axis (the Y axis) in the width direction of the lane L2 (that is, a distance in the longitudinal direction (the X axis direction) of the lane L2 is zero (0)). In this case, the second trajectory generator 144 sets a distance between the point PRL(t2) and the standard position OBP1 as a shift amount Sh1 and determines a position moved by the shift amount Sh1 in a direction away from the road demarcation line RL with respect to the second standard point P2(t2) as a second trajectory point P2#(t2) after the movement.

The second trajectory generator 144 moves the second point P2(t3) since a distance BP3 between the point PCL(t3) and the standard position OBP2 which is the closest among the standard positions OBP1 to OBP3 is shorter than the lane width WL2 at time t3. In the case of time t3, the standard position OBP2 and the second trajectory point P2(t3) do not exist at positions horizontal to the Y axis. Accordingly, the second trajectory generator 144 determines an amount by which the second trajectory point P2(t3) is moved in the width direction of the lane L2 based on a distance in the longitudinal direction (the X axis direction) of the lane L2.

For example, the second trajectory generator 144 causes the amount of the movement of the second trajectory point P2(t3) in the width direction of the lane L2 to be less than a distance between the standard position OBP2 and the point PRL(t3) as the distance between the position of the second trajectory point P2(t3) near the standard position OBP2 and the standard position OPB2 in the longitudinal direction of the lane L2 increases. For example, the second trajectory generator 144 may calculate a shift amount Sh2 using a trigonometric function or the like. For example, the second trajectory generator 144 calculates the shift amount Sh2 using Expression (1) below.

Shift amount Sh2=lane width WL2−distance BP3×cos θ1 (1)

Here, the angle θ1 is an angle formed between the Y axis in the drawing and a straight line connecting the point PCL(t3) to the standard position OBP2.

The second trajectory generator 144 may calculate the shift amount using position coordinates (x1, y1) of the point PCL(t3), position coordinates (x2, y2) of the standard position OBP2, and position coordinates (x3, y3) of the point PRL(t3). In this case, the second trajectory generator 144 first sets a first vector A=(a1, b1) connecting the point PCL(t3) to the point OBP2 and a second vector B=(a2, b2) connecting the point PCL(t3) to the point PRL(t3). In the first vector A, relations of the component a1=x2−x1 and the component b1=y2−y1 are established. In the second vector B, relations of the component a2=x3−x1 and the component b2=y3−y1 are established. Subsequently, the second trajectory generator 144 calculates the shift amount Sh2 using Expression (2) below in accordance with an expression of an inner product in which the components of the above-described two vectors are used.

$$\begin{matrix} [ Math . 1 ] & \\ Shift amount Sh 2 = lane width WL 2 - distance BP 3 \times ( \frac{a 1 \times a 2 + b 1 \times b 2}{\sqrt{a {1}^{2} + b {1}^{2}} \sqrt{a {2}^{2} + b {2}^{2}}} ) & ( 2 )\end{matrix}$$

The second trajectory generator 144 determines a position shifted by the distance Sh2 in a direction away from the road demarcation line RL by the acquired shift amount Sh2 with respect to the second standard point P2(t3) as a second trajectory point P2#(t3) after the movement.

The second trajectory generator 144 moves the second point P2(t4) since a distance BP4 between the point PCL(t4) and the standard position OBP3 which is the closest among the standard positions OBP1 to OBP3 is shorter than the lane width WL2 at time t4. In the case of time t4, the standard position OBP3 and the second trajectory point P2(t4) do not exist at positions horizontal to the Y axis. Accordingly, the second trajectory generator 144 uses the above-described predetermined function or an angle θ2 or the like formed between the Y axis in the drawing and a straight line connecting the point PCL(t4) to the standard position OBP3 to determine a shift amount Sh3 by which the second trajectory point P2(t3) is moved based on the distance in the longitudinal direction (the X axis direction) of the lane L2. Then, the second trajectory generator 144 determines a position shifted by the distance Sh3 in a direction away from the road demarcation line RL by the acquired shift amount Sh3 with respect to the second standard point P2(t4) as a second trajectory point P2#(t4) after the movement.

Thus, the second trajectory generator 144 generates a shifted second trajectory K2# passing through the second trajectory points P2(t1), P2#(t2) to (t4), P2(t5), and P2(t6) obtained by moving the parts of the second trajectory K2 based on a change in a behavior of the own vehicle M due to the obstacles OB1 to OB3.

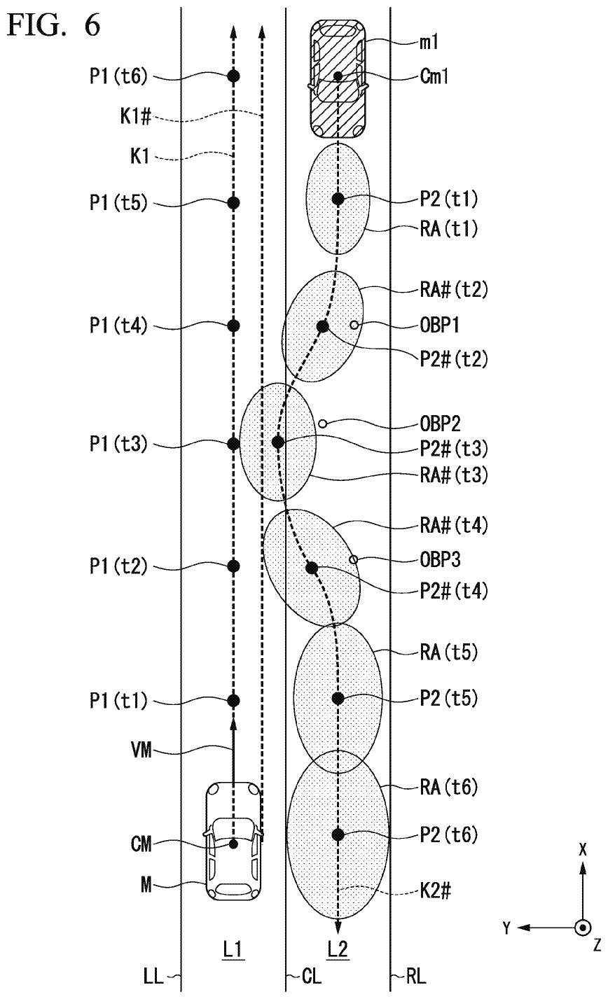

The interference determiner 146 determines whether the first trajectory K1 interferes with the shifted second trajectory K2#. FIG. 6 is a diagram showing a process of the interference determiner 146 when obstacles are on the traveling road. For example, the interference determiner 146 generates risk areas RA(t1), RA#(t2) to RA#(t4), RA(t5), and RA(t6) corresponding to the second trajectory points P2(t1), P2#(t2) to P2#(t4), P2(t5), and P2(t6) included in the shifted second trajectory K2# generated by the second trajectory generator 144. Then, the interference determiner 146 determines whether the risk areas RA(t1), RA#(t2) to RA#(t4), RA(t5), and RA(t6) intersect the offset trajectory K1 of the own vehicle M. Here, in the example of FIG. 6, the risk area RA(t3) at time t3 intersects the offset trajectory K1 and a time at which the own vehicle M is traveling in the intersecting portion is a time including time t3. Accordingly, the interference determiner 146 determines that the first trajectory K1 interferes with the shifted second trajectory K2# (in other words, the own vehicle M is likely to come into contact with the oncoming vehicle m1 in future).

The action plan generator 140 determines whether the own vehicle M is caused to travel or stop based on a determination result of the interference determiner 146, generates an action plan based on the determined content, and performs driving control of the own vehicle M based on the generated action plan. For example, when the interference determiner 146 determines that the first trajectory interferes with the second trajectory before the oncoming vehicle m1 passes by the obstacle, the action plan generator 140 generates an action plan to cause the own vehicle M to stop at a predetermined position until the oncoming vehicle m1 passes by the obstacle. The fact that the oncoming vehicle m1 passes by the obstacle means that the oncoming vehicle m1 is traveling avoiding the obstacle and the oncoming vehicle m1 is moving, for example, from a position distant from the obstacle to a position closer than the obstacle in the longitudinal direction of the lane L2.

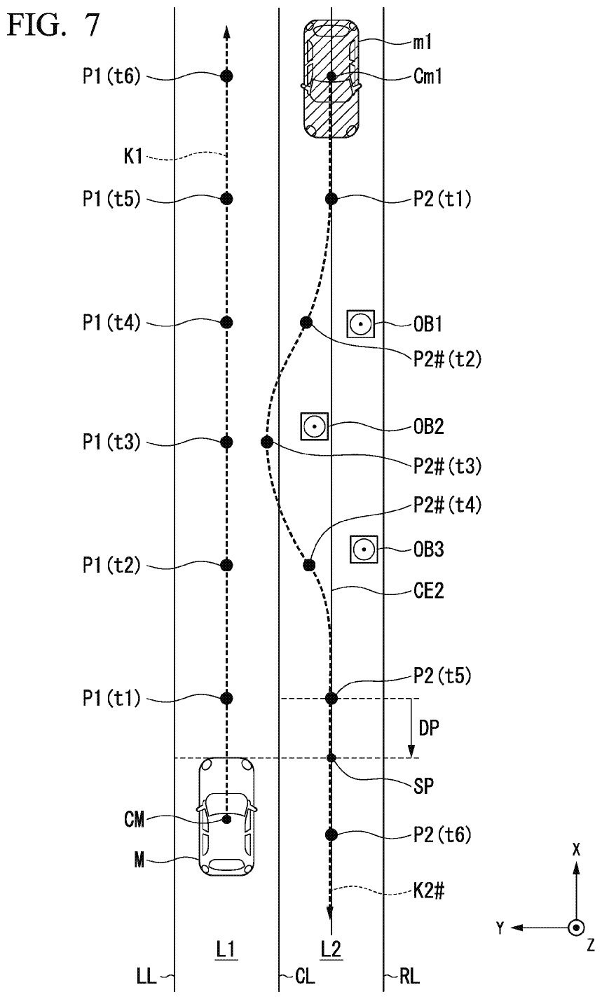

FIG. 7 is a diagram showing a stop position of the own vehicle M. In the example of FIG. 7, the first trajectory K1 and the shifted second trajectory K2# in the traveling roads (the lanes L1 and L2) are shown. For example, the action plan generator 140 generates an action plan to cause the own vehicle M to stop at a position located a predetermined distance before a position predicted to return to a trajectory before the movement in the direction in which the second trajectory K2# moves away from the road demarcation line RL (that is, the second middle portion CE2 of the lane L2) in the width direction of the lane L2 after the oncoming vehicle m2 passes by the obstacles OB1 to OB3.

In the example of FIG. 7, the position predicted to return to the second middle portion CE2 again after the oncoming vehicle m1 passes by the obstacles OB1 to OB3 is the second trajectory point P2(t5). Accordingly, the action plan generator 140 causes the own vehicle M to stop at the spot SP located at a predetermined distance DP from the second trajectory point P2(t5) in the longitudinal direction of the lane L2. The predetermined distance DP may be a fixed distance or may be a distance set to be variable based on the speed Vm1 or the like of the oncoming vehicle m1. Thus, it is possible to inhibit contact with the oncoming vehicle m1 passing the obstacles and it is possible to cause the oncoming vehicle m1 to travel smoothly avoiding the obstacles.

The action plan generator 140 generates an action plan to cause the own vehicle M to travel along the first trajectory K1 when the oncoming vehicle m1 has moved to a position at which there is no interference in the own vehicle M.

### [Process Flow]

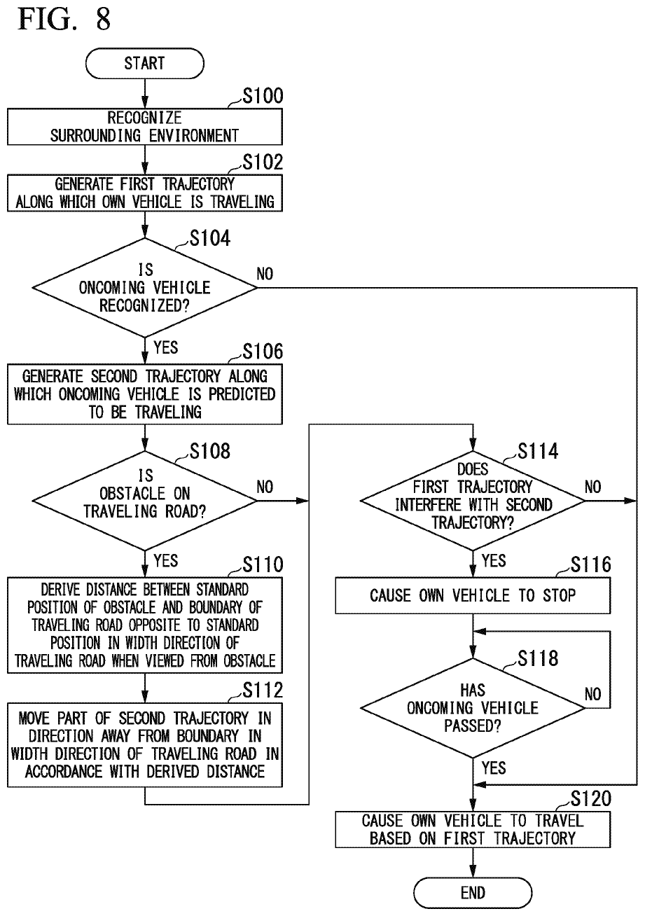

FIG. 8 is a flowchart showing an example of a flow of a process performed by the automated driving control device 100 according to an embodiment. First, the recognizer 130 recognizes a surrounding environment of the own vehicle M (step S100). Subsequently, the first trajectory generator 142 generates a first trajectory based on the surrounding environment recognized by the recognizer 130 (step S102). Subsequently, the oncoming vehicle recognizer 132 determines whether the oncoming vehicle m1 is recognized (step S104). When the oncoming vehicle m1 is determined to be recognized, the second trajectory generator 144 generates a second trajectory in which the oncoming vehicle m1 is predicted to be traveling (step S106).

Subsequently, the obstacle recognizer 134 determines whether an obstacle is on a traveling road of the own vehicle M (step S108). When the obstacle is determined to be on the traveling road, the second trajectory generator 144 derives a distance between the standard position of the obstacle and a boundary of the traveling road opposite to the standard position in the width direction of the traveling road when viewed from the obstacle (step S110) and moves a part of the second trajectory in a direction away from the boundary in the width direction of the traveling road in accordance with the derived distance (step S112).

When it is determined that the obstacle is not on the traveling road after the process of step S112 or in the process of step S108, the interference determiner 146 determines whether the first trajectory interferes with the second trajectory (step S114). When the first trajectory is determined to interfere with the second trajectory, the action plan generator 140 generates an action plan to cause the own vehicle M to stop at a predetermined position (step S116). Subsequently, the recognizer 130 determines whether the oncoming vehicle m1 has passed the obstacle (step S118). When it is determined that the oncoming vehicle m1 has not passed by the obstacle, the action plan generator 140 waits until the oncoming vehicle m1 passes.

When the oncoming vehicle m1 has passed the obstacle and when it is determined in the process of step S104 that the oncoming vehicle m1 is not recognized or the obstacle is not on the traveling road in the process of step S108, the action plan generator 140 causes the own vehicle M to travel based on the first trajectory (step S120). Then, the process of the flowchart ends.

In the above-described embodiment, the action plan generator 140 causes the own vehicle M for which the first trajectory is determined to interfere with the second trajectory to stop at the predetermined position. However, instead of this, speed control may be performed such that the own vehicle M decelerates or accelerates so that the own vehicle M does not come into contact with the oncoming vehicle m1 at a predetermined time.

### MODIFICATION EXAMPLES

Hereinafter, modification examples of the above-described embodiment will be described.

### First Modification Example

In the above-described embodiment, the interference determiner 146 generates the risk area RA based on the speed and the traveling direction of the oncoming vehicle m1. However, instead of this, a risk area may be generated based on a bounding box BB surrounding the outer shape of the oncoming vehicle m1.

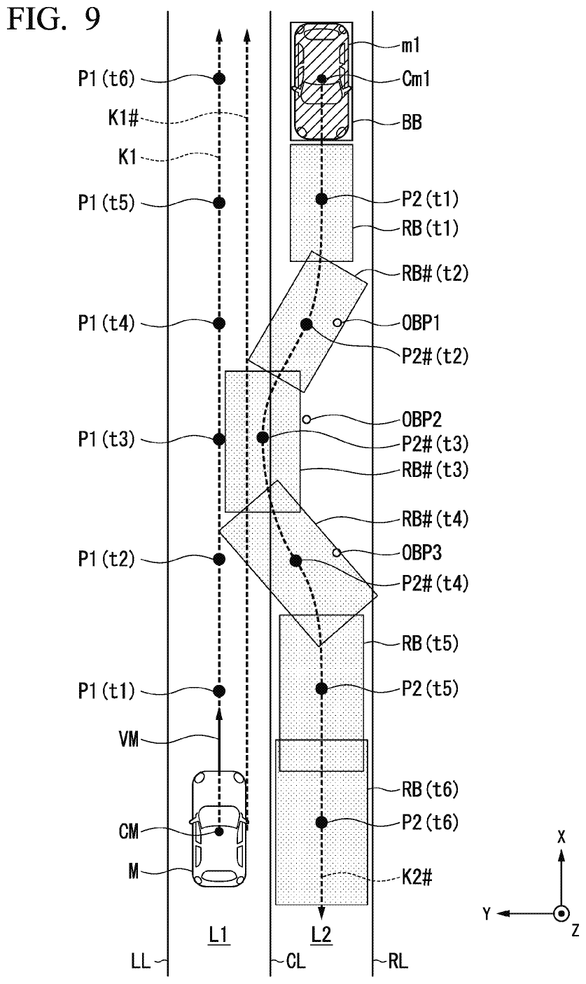

FIG. 9 is a diagram showing another example in which a risk area is generated. In the example of FIG. 9, a similar scenario to the scenario of FIG. 6 described above is shown to facilitate description. The interference determiner 146 generates the bounding box BB surrounding the outer shape of the oncoming vehicle m1 based on outer shape information of the oncoming vehicle m1 recognized by the oncoming vehicle recognizer 132. In the example of FIG. 9, a rectangular area is generated as the bounding box BB, but an area with another polygon, a circular, an ellipse, or the like may be used. Then, the interference determiner 146 expands the generated bounding box BB over time and generates risk areas at times t1 to t6. In the example of FIG. 9, risk areas RB(t1), RB#(t2) to RB#(t4), RB(t5), and RB(t6) are set.

In this way, by setting the risk areas using the bounding box BB, it is possible to further reduce a process road than predicting a change in a speed of the oncoming vehicle M as an amount of a behavior and setting the risk areas. Therefore, for example, even when the own vehicle passes by the oncoming vehicle in a state in which a speed is fast, interference can be determined in a short time.

The interference determiner 146 may set areas in accordance with the above-described risk areas RA and RB and determine the interference using the set areas. Thus, it is possible to determine the interference more safely.

### Second Modification Example

Next, a second modification example will be described. In the above-described embodiment, the action plan generator 140 generates the action plan to cause the own vehicle M to stop at the predetermined position until the oncoming vehicle m1 passes by an obstacle when the interference determiner 146 determines that the first trajectory interferes with the second trajectory before the oncoming vehicle m1 passes by the obstacle. Instead of (or in addition to) this, the action plan generator 140 may determine whether the own vehicle M is caused to travel or stop in accordance with whether the oncoming vehicle m1 arrives a predetermined position on a traveling road earlier than the own vehicle M. The predetermined position is, for example, a spot at which the own vehicle M is predicted to interfere with the oncoming vehicle m1. In the example of FIG. 9, the predetermined position is a position at which there is the obstacle OB2 located at a distance closest to a middle (the road demarcation line CL) of the traveling road including the lanes L1 and L2 (for example, a position at which the standard position OBP2 is in the longitudinal direction of the traveling road). As the predetermined position, different positions may be set for the own vehicle M and the oncoming vehicle m1. In this case, the predetermined position is, for example, a position at which an obstacle is the closest to a current position of each vehicle in the longitudinal direction of the traveling road (in the example of FIG. 9, a position at which there is the standard position OBP3 of the obstacle OB3 in the case of the own vehicle M or a position at which there is the standard position OBP1 of the obstacle OB1 in the case of the oncoming vehicle m1).

For example, when the oncoming vehicle m1 is predicted to arrive at the predetermined position earlier than the own vehicle M compared to a predicted position of each vehicle at each time based on the first trajectory K1 and the second trajectory K2#, the action plan generator 140 causes the own vehicle M to stop. When the own vehicle M is predicted to arrive at the predetermined position earlier than the oncoming vehicle m1, the action plan generator 140 causes the own vehicle M to travel along the first trajectory K1. Thus, since a vehicle predicted to arrive earlier at an area in which there is a possibility of interference can be preferentially caused to travel, it is possible to realize more smooth traffic.

### Third Modification Example

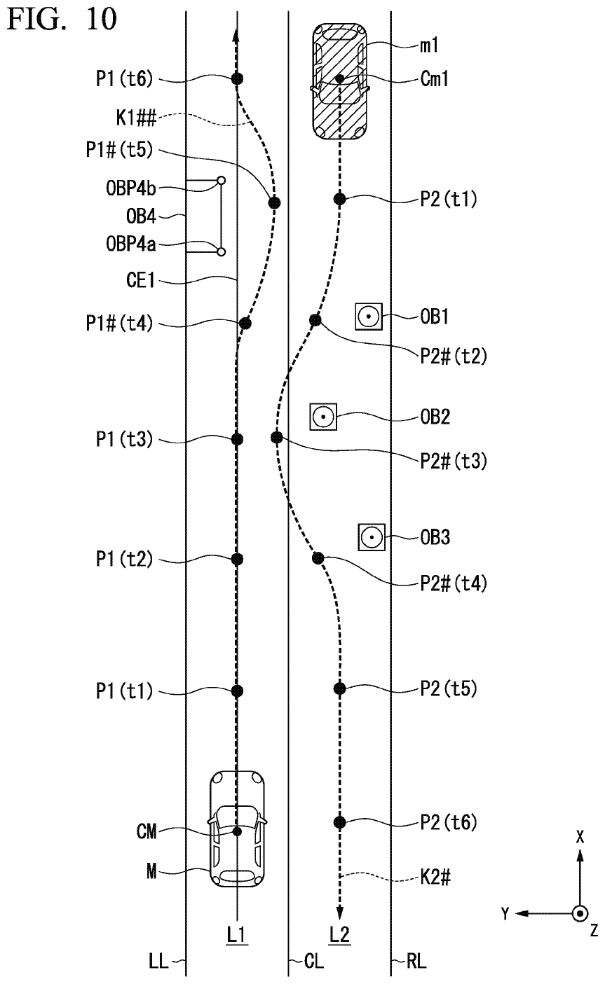

Next, a third modification will be described. In the above-described embodiment, the movement of the parts of the trajectory (the second trajectory) of the oncoming vehicle m1 due to the obstacles has been described. However, instead of or in addition to this, a part of the trajectory (the first trajectory) along which the own vehicle M is traveling may be moved. FIG. 10 is a diagram showing movement in a part of the first trajectory according to the third modification example. In the example of FIG. 10, an obstacle OB4 is on the lane L1 in addition to the above-described obstacles OB1 to OB3. In this case, the obstacle recognizer 134 recognizes positions, shapes, sizes, or the like of the obstacles OB1 to OB4. Since the obstacles OB1 to OB3 are on the lane L2, the second trajectory generator 144 generates the shifted second trajectory K2 obtained by moving the part of the second trajectory K2 of the oncoming vehicle m1 traveling in the lane L2, as described above.

In the third modification example, since the obstacle OB4 is on the lane L1, the first trajectory generator 142 generates a shifted first trajectory K1## obtained by moving parts of the first trajectory K1 in a direction away from the road demarcation line LL in the width direction of the lane L1 in accordance with distances between standard positions OBP4a and OBP4b set for the obstacle OB4 and a boundary (for example, the road demarcation line LL) of the lane L1 opposite to the standard positions OBP4a and OBP4b in the width direction of the traveling road when viewed from a middle portion of the obstacle OB4.

The action plan generator 140 compares a first timing at which the own vehicle M is moved in a direction away from the road demarcation line LL along the shifted first trajectory K1## with a second timing at which the oncoming vehicle m1 is moved in a direction away from the road demarcation line RL along the shifted second trajectory K2#. Then, the action plan generator 140 causes the own vehicle M to stop when the first timing is the same as or later than the second timing, and causes the own vehicle M to travel along the shifted first trajectory K1## when the first timing is earlier than the second timing. In the example of FIG. 10, since the first timing is near time t4 and the second timing is near time t2, the second timing is earlier than the first timing. Accordingly, the action plan generator 140 causes the own vehicle M1 to stop at a predetermined position until the oncoming vehicle m1 passes by the obstacles OB1 to OB3. Thus, it is possible to perform more appropriate driving control.

### Fourth Modification Example

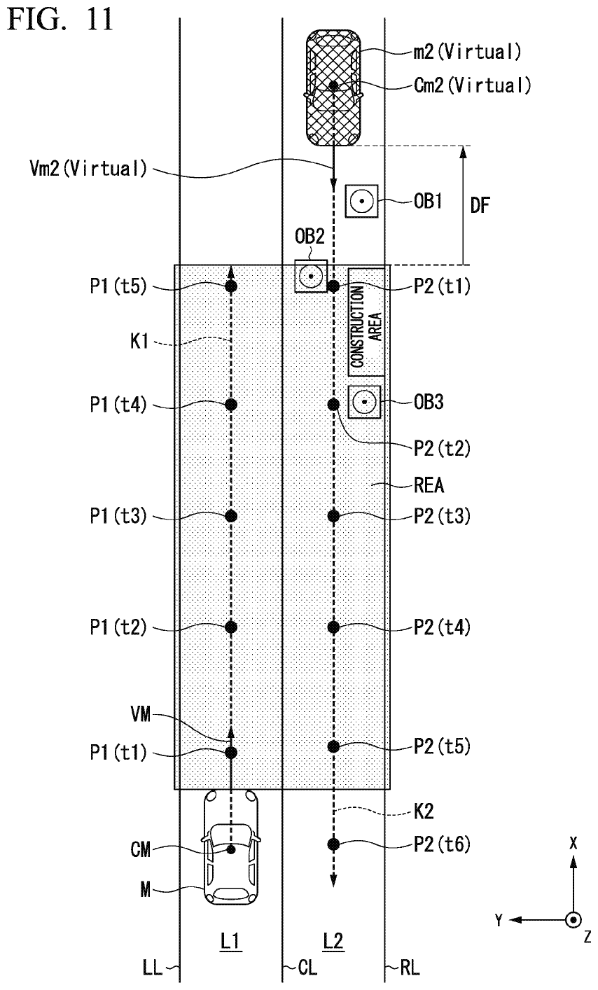

Next, a fourth modification example will be described. In the fourth modification, when the recognizer 130 recognizes an obstacle near a boundary of a recognizable range, the second trajectory is generated on the assumption that there is a virtual oncoming vehicle. FIG. 11 is a diagram showing the fourth modification example.

In the example of FIG. 11, a recognizable range REA in the recognizer 130 is shown.

In the example of FIG. 11, the obstacle recognizer 134 recognizes the obstacles OB2 and OB3. The obstacle OB2 is near the boundary of the recognizable range REA (for example, within several [m] from the boundary). The oncoming vehicle recognizer 132 does not recognize an oncoming vehicle within the recognizable range REA. In this case, the second trajectory generator 144 assumes that a virtual oncoming vehicle m2 (Virtual) is at a position which is farther than the obstacle OB2 when viewed from the own vehicle M and is located at a predetermined distance from the obstacle OB2 or the recognizable range REA. In the example of FIG. 11, the virtual oncoming vehicle m2 (Virtual) is assumed to be at a position distant by a distance DF from the recognizable range REA.

The second trajectory generator 144 generates the second trajectory point P2 or the second trajectory K2 so that a standard position (for example, a center Cm2 (Virtual)) of the virtual oncoming vehicle m2 (Virtual) passes through the middle portion in the transverse direction of the lane L2 by using the virtual oncoming vehicle m2 (Virtual), as described above, and generates the shifted second trajectory obtained by moving at least parts of the generated second trajectory K2 in a direction in which contact with the obstacles OB2 and OB3 is avoided. As a speed Vm2 (Virtual) of the oncoming vehicle m2 (Virtual), for example, a legal speed limit of the lane L2 or the speed VM of the own vehicle M is used.

According to the above-described fourth modification example, when an obstacle is near the boundary of the recognizable range and an oncoming vehicle is not recognized, more appropriate driving control can be performed by predicting presence of the oncoming vehicle which has traveled before the recognition and generating an action plan. Even when the oncoming vehicle is traveling at a high speed, spare driving control can be performed by predicting a traveling trajectory in accordance with the virtual oncoming vehicle.

### Fifth Modification Example

Next, a fifth modification example will be described. In the above-described embodiment, the traveling road on which there are the own lane (the lane L1) and the oncoming lane (the lane L2) has been described. For example, when the own vehicle passes by the oncoming vehicle m1 on a narrow road with one lane, the recognizer 130 may set a virtual road demarcation line CL (Virtual) in the middle portion in the longitudinal direction of the traveling road, set a lane on the own vehicle side between two lanes demarcated by the road demarcation line CL as the own vehicle (the lane L1), and recognize the lane on the oncoming vehicle side as the oncoming lane (the lane L2). Thus, even when the own vehicle passes by an oncoming vehicle in a traveling road with one lane, a traveling trajectory of the oncoming vehicle in a case in which an obstacle is on the traveling road can be predicted with higher precision. As a result, it is possible to perform more appropriate driving control of the own vehicle M.

According to the above-described embodiment, the vehicle control device 100 includes: the recognizer 130 configured to recognize a surrounding environment of the own vehicle M; the first trajectory generator 142 configured to generate a first trajectory along which the own vehicle M is traveling based on a recognition result of the recognizer 130; the second trajectory generator 144 configured to generate a second trajectory along which an oncoming vehicle is predicted to be traveling in a direction in which the own vehicle M encounters the oncoming vehicle based on the recognition result of the recognizer 130; and the driving controller (the action plan generator 140 and the second controller 160) configured to perform driving control on one or both of a speed and steering of the own vehicle M based on whether the first trajectory interferes with the second trajectory. The second trajectory generator 144 moves a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the recognizer 130 recognizes that the obstacle is on the traveling road. Thus, it is possible to predict a traveling trajectory of an oncoming vehicle with high precision when an obstacle is on a traveling road.

For example, in an embodiment, when a vehicle is traveling along a lane and when an obstacle is on the lane on the basis of the fact that a future position of the vehicle is on a trajectory (base path) on the middle of the lane, a shift amount of the base path is obtained to avoid the obstacle and a traveling trajectory is changed in association with the obtained shift amount, and thus it is possible to predict a future traveling trajectory of an oncoming vehicle at the time of avoidance of the obstacle with higher precision. As a result, the own vehicle M can perform more appropriate driving control.

### [Hardware Configuration]

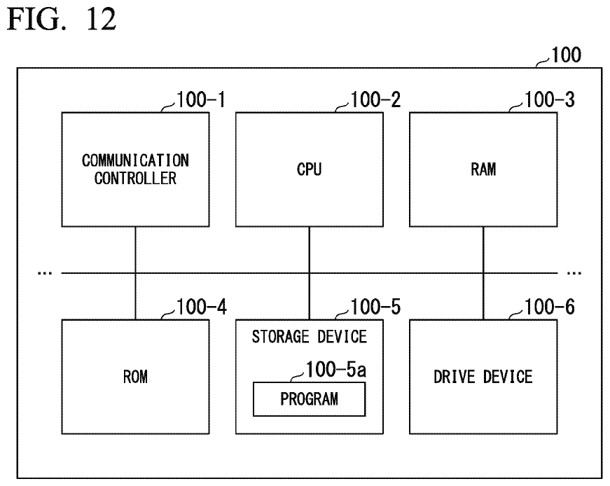

FIG. 12 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with a constituent element other than the automated driving control device 100. The storage device 100-5 stores a program 100-5a that is executed by the CPU 100-2. The program is loaded on the RAM 100-3 by a direct memory access (DMA) controller (not shown) to be executed by the CPU 100-2. Thus, some or all of the recognizer 130 and the action plan generator 140 are realized.

The above-described embodiment can be expressed as follows:

a vehicle control device including a storage device that stores a program and a hardware processor, the hardware processor executing the program stored in the storage device,

to recognize a surrounding environment of an own vehicle;

to generate a first trajectory along which the own vehicle is traveling based on a recognition result;

to generate a second trajectory along which an oncoming vehicle is predicted to be traveling in a direction in which the own vehicle encounters the oncoming vehicle based on the recognition result;

to perform driving control on one or both of a speed and steering of the own vehicle based on whether the first trajectory interferes with the second trajectory; and

to move a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer configured to recognize a surrounding environment of an own vehicle;
a first trajectory generator configured to generate a first trajectory along which the own vehicle is traveling based on a recognition result of the recognizer;
a second trajectory generator configured to generate a second trajectory along which an oncoming vehicle is predicted to be traveling in a direction in which the own vehicle encounters the oncoming vehicle based on the recognition result of the recognizer; and
a driving controller configured to perform driving control on one or both of a speed and steering of the own vehicle based on whether the first trajectory interferes with the second trajectory,
wherein the second trajectory generator moves a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the recognizer recognizes that the obstacle is on the traveling road.

2. The vehicle control device according to claim 1,
wherein the second trajectory includes a plurality of second trajectory points formed at predetermined intervals in a longitudinal direction of the traveling road, and
wherein the second trajectory generator determines an amount of movement of the second trajectory points in the width direction based on a distance between a position of the second trajectory point near the standard position and the standard position in the longitudinal direction of the traveling road.

3. The vehicle control device according to claim 2, wherein the second trajectory generator causes the amount of the movement of the second trajectory points in the width direction to be less than a distance between the standard position and the boundary as the distance between the position of the second trajectory point near the standard position and the standard position in the longitudinal direction of the traveling road increases.

4. The vehicle control device according to claim 1, wherein, when the first trajectory is predicted to interfere with the second trajectory before the oncoming vehicle passes by the obstacle, the driving controller causes the own vehicle to stop until the oncoming vehicle passes by the obstacle.

5. The vehicle control device according to claim 1, wherein the driving controller causes the own vehicle to stop when the oncoming vehicle is predicted to arrive at a predetermined position on the traveling road earlier than the own vehicle, and the driving controller causes the own vehicle to travel along the first trajectory when the own vehicle is predicted to arrive at the predetermined position earlier than the oncoming vehicle.

6. The vehicle control device according to claim 1,
wherein, when the recognizer recognizes that an obstacle is on the traveling road, the first trajectory generator moves a part of the first trajectory in a direction away from a boundary of the traveling road in a width direction of the traveling road in accordance with a distance between the standard position and the boundary of the traveling road opposite to the standard position in the width direction of the traveling road when viewed from a center portion of the obstacle, and
wherein the driving controller causes the own vehicle to stop when a first timing at which the own vehicle is moved in the direction away from the boundary along the first trajectory is later than or the same as a second timing at which the oncoming vehicle moves in the direction away from the boundary along the second trajectory, and the driving controller causes the own vehicle to travel along the first trajectory when the first timing is earlier than the second timing.

7. The vehicle control device according to claim 4, wherein the driving controller causes the own vehicle to stop at a position located a predetermined distance before a position predicted to return to a trajectory before the movement of the traveling road in the direction in which the second trajectory moves away from the boundary in the width direction of the traveling road after the oncoming vehicle passes by the obstacle.

8. The vehicle control device according to claim 1, wherein, when the recognizer recognizes an obstacle near a boundary of a recognizable range of the traveling road and the recognizer does not recognize an oncoming vehicle, the second trajectory generator generates the second trajectory on assumption that a virtual oncoming vehicle is at a position which is farther from the obstacle when viewed from the own vehicle and is located at a predetermined distance from the obstacle or the recognizable range.

9. A vehicle control method causing a computer:
to recognize a surrounding environment of an own vehicle;
to generate a first trajectory along which the own vehicle is traveling based on a recognition result;
to generate a second trajectory along which an oncoming vehicle is predicted to be traveling in a direction in which the own vehicle encounters the oncoming vehicle based on the recognition result;
to perform driving control on one or both of a speed and steering of the own vehicle based on whether the first trajectory interferes with the second trajectory; and
to move a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.

10. A computer-readable non-transitory storage medium that stores a program causing a computer:
to recognize a surrounding environment of an own vehicle;
to generate a first trajectory along which the own vehicle is traveling based on a recognition result;
to generate a second trajectory along which an oncoming vehicle is predicted to be traveling in a direction in which the own vehicle encounters the oncoming vehicle based on the recognition result;
to perform driving control on one or both of a speed and steering of the own vehicle based on whether the first trajectory interferes with the second trajectory; and
to move a part of the second trajectory in a direction away from a boundary of a traveling road in a width direction of the traveling road in accordance with a distance between a standard position set on an obstacle and the boundary of the traveling road opposite to the standard position in the width direction of the traveling road when viewed from a center portion of the obstacle when the obstacle is recognized as being on the traveling road.
